(19) United States
(12) Patent Application Publication
(10) Pub. No.: US 2019/0270466 A1
(43) Pub. Date: Sep. 5, 2019

(54) APPARATUS FOR TRANSPORTING HANGING CROPS

(71) Applicant: THE FLOWR CANNABIS ULC, Markham (CA)

(72) Inventor: Thomas Flow, Kelowna (CA)

(21) Appl. No.: 15/912,377

(22) Filed: Mar. 5, 2018

(51) Int. Cl. B62B 3/00; B62B 3/10

(52) U.S. Cl. CPC B62B 3/005; B62B 3/10; A01G 9/143; B62B 2202/70; B62B 3/004

(57) ABSTRACT

An apparatus for transporting hanging crops comprising a container having an open top and defining an interior compartment extending between first and second sides, a plurality of rigid elongate rods adapted to span between the first and second sides of the container, a plurality of pairs of rod supports secured to the first and second sides of the container proximate to the open top, adapted to removably receive the plurality of rigid elongate rods thereon; and a plurality of rollers secured to a bottom of the container. A method for transporting hanging crops supporting a plurality of crops along each of the plurality of elongate rods, adapted to span between the first and second sides of the container and lowering each of the plurality of elongate rods with the plurality of crops thereon into the interior compartment and suspending each of the plurality of elongate rods from the pairs of rod supports.

### BACKGROUND OF THE INVENTION

### 1. Field of Invention

The present invention relates generally to an apparatus for transporting hanging crops, and in particular to an enclosed rolling cart for transporting dried cannabis.

### 2. Description of Related Art

Following harvest of the cannabis plant, the trimmed plant is hung to dry and cure. The plant may be cured in one location and packaged for distribution at another location. The dried plants must then be transported between the two locations. To prevent damage to the plants during transportation, they are transported in a suspended (hanging) state, so that the dried product is not subjected to damaging impact forces.

Previous devices have been provided to transport hanging, cured crops. These devices do not include removable hanging rods within. They therefore require manual removal of each individual plant or bulk removal, subjecting the plants to potentially damaging impact forces. Additionally, these devices do not include a removable catch tray to facilitate reclamation of any plant parts that may fall from the hangers. Examples of such devices include U.S. Pat. No. 3,935,959 to Long and U.S. Pat. No. 4,520,579 to De Cloet et al.

### SUMMARY OF THE INVENTION

According to a first embodiment of the present invention there is disclosed an apparatus for transporting hanging crops comprising a container having an open top and defining an interior compartment extending between first and second sides, a plurality of rigid elongate rods adapted to span between the first and second sides of the container, a plurality of pairs of rod supports secured to the first and second sides of the container proximate to the open top, adapted to removably receive the plurality of rigid elongate rods thereon; and a plurality of rollers secured to a bottom of the container.

The container may be formed in a generally rectangular configuration. The container may include a longitudinal horizontal open slot extending through the container proximate to the bottom thereof. The slot may extend through a front or a back of the container.

The apparatus may further comprise a removable tray corresponding to a bottom of the interior compartment and adapted to pass through the open slot. The tray may include upright walls extending around a periphery thereof and defining a containment area therein. The tray may include a handle extending outward from one of the upright walls.

The apparatus may further comprise a lid adapted to enclose the open top. The lid may include a locking mechanism adapted to secure the lid to the container. The lid may be attached to the container with a hinge. The lid may include a locking mechanism adapted to secure the lid to the container and located at an opposite end of the lid to the hinge.

According to a further embodiment of the present invention there is disclosed a method for transporting hanging crops comprising providing a container having a plurality of rollers secured to a bottom thereof, the container having an open top and defining an interior compartment extending between first and second sides and having a plurality of pairs of rod supports secured to the first and second sides of the container proximate to the open top, the pairs of rod supports adapted to removably receive a plurality of elongate rods thereon. The method further comprises supporting a plurality of crops along each of the plurality of elongate rods, adapted to span between the first and second sides of the container and lowering each of the plurality of elongate rods with the plurality of crops thereon into the interior compartment and suspending each of the plurality of elongate rods from the pairs of rod supports.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an exploded perspective view of an apparatus for transporting hanging crops according to a first embodiment of the invention.

FIG. 2 is a perspective view of a further embodiment of the invention, with a hinged lid.

FIG. 3 is a perspective view of the apparatus of FIG. 1 with a handle on the lid.

### DETAILED DESCRIPTION

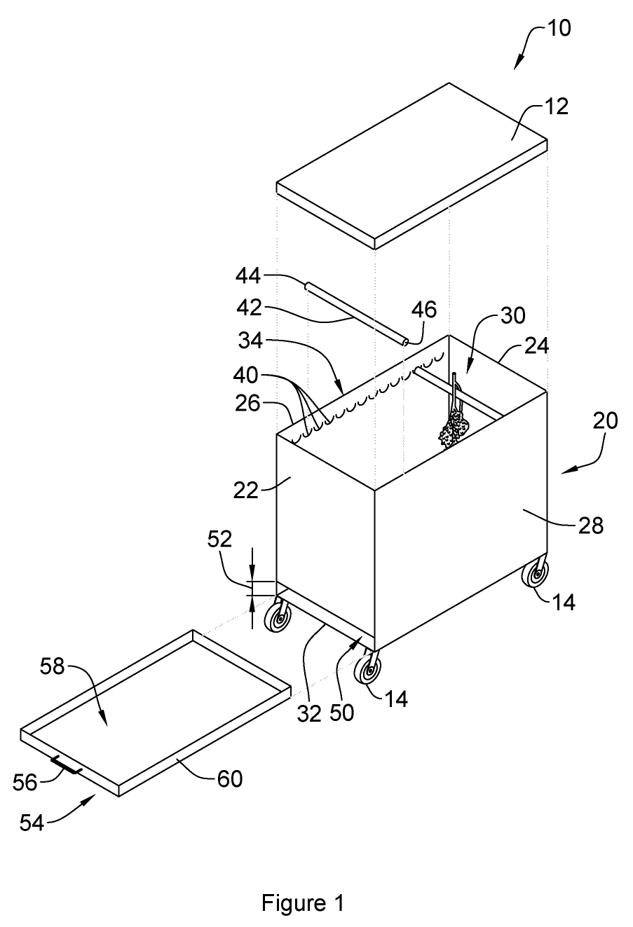

Referring to FIG. 1, an apparatus for transporting hanging crops 8 according to a first embodiment of the invention is shown generally at 10. The apparatus 10 includes an open-topped box structure container 20 defining an interior compartment 30 with a plurality of elongate rods 42 supported therein, on which the hanging crops 8 are distributed, as is commonly known in the art. A removable tray 54 is adapted to rest on a bottom 32 within the container 20 and passes through a slot 50 in the container 20 to reclaim crop product which falls from the hanging crops 8 during use. A lid 12 is adapted to enclose the top of the container 20. Transportation of the apparatus 10 is facilitated with a plurality of rollers 14 extending from the bottom 32.

The container 20 extends between front and back walls, 22 and 24, respectively, and between first and second side walls, 26 and 28, respectively, and includes a solid bottom 32 and an open top 34, as outlined above. A plurality of pairs of rod supports 40 are distributed along the first and second side walls, 26 and 28, proximate to the top 34. Each pair of rod supports 40 is adapted to support a rod 42 thereon. The rod supports 40 may be formed as, such as by way of non-limiting example, “U” or “V” shaped brackets, although it will be appreciated that other methods of support may be useful, as well.

Each rigid elongate rod 42 extends between first and second ends, 44 and 46, respectively, and is adapted to span the interior compartment 30 between the first and second side walls, 26 and 28. The rods 42 may have a circular or oval cross-section, as illustrated, although it will be appreciated that other cross-sectional shapes may be useful, as well. As outlined above, the rods 42 are supported on the rod supports 40, at the first and second ends, 44 and 46. The rods are removable and may be individually removed from the container 20, as desired by a user.

The front wall 22 includes a slot 50 extending between the first and second side walls, 26 and 28, proximate to the bottom 32. The slot has a height 52 in the range such as, by way of non-limiting example, 1 inches to 6 inches (25 mm to 152 mm). The tray 54, having upright side walls 60 around a periphery thereof, is adapted to pass through the slot 50 and rest on the bottom 32 of the container 20, substantially covering the bottom 32 so that fallen product is retained within a containment area 58 between the side walls 60 on the tray 54. The tray 54 includes a front handle 56 extending therefrom a side wall 60, to facilitate removal of the tray 54 from the container 20 through the slot 50. It will be appreciated that alignment rails (not shown), as are commonly known, may be included within the container 20 on the first and second side walls 26 and 28 above the slot 50 to maintain the tray 54 in alignment as it is removed from the container 20.

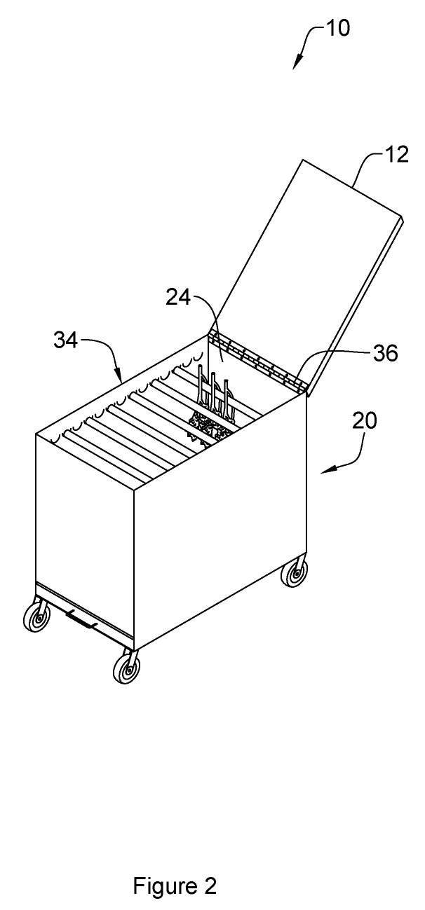

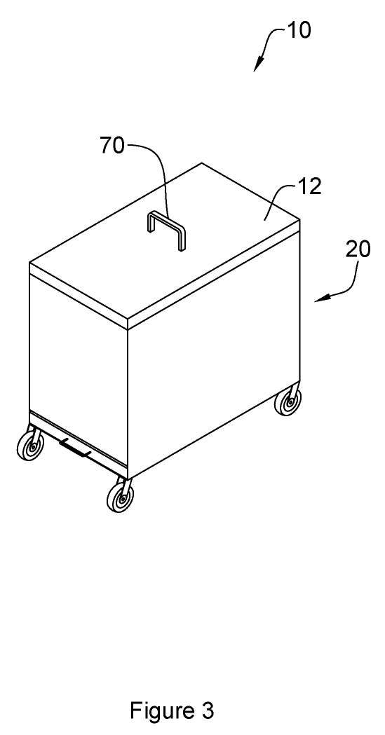

The removable lid 12 is adapted to span the open top 34 of the container 20, and may be secured thereon by one or more locking mechanisms (not shown), as are commonly known. Optionally, as illustrated in FIG. 2, the lid 12 may be pivotably attached to the container 20 along the top edge of the back wall 24 with a hinge 36, as is commonly known. A handle 70 may be included on the top of the lid 12, as illustrated in FIG. 3.

Prior to use, the removable tray 54 is inserted into the container 20 through the slot 50. The crops 8 are placed on the rods 42, as is commonly known in the art. The crops 8 may be placed onto the rods 42 prior to placing the rods 42 within the container, such that the rods 42 are lowered into the interior compartment 30 and onto the rod supports 40 with the crops 8 thereon, or, alternatively, the crops 8 may be placed onto the rods 42 after the rods 42 are installed and mated on the rod supports 40. The lid 12 is lowered into place when all rods 42 have been installed within the container 20 with crops 8 thereon, enclosing the interior compartment 30. The lid 12 may optionally be locked in place. A user then moves the apparatus 10 to a second location, facilitated by the rollers 14. After the crops 8 have been removed from the apparatus 10, the removable tray 54 may be withdrawn from the container 20 through the slot 50 to reclaim any dropped product.

While specific embodiments of the invention have been described and illustrated, such embodiments should be considered illustrative of the invention only and not as limiting the invention as construed in accordance with the accompanying claims.

What is claimed is:

1. An apparatus for transporting hanging crops comprising:
a container having an open top and defining an interior compartment extending between first and second sides;
a plurality of rigid elongate rods adapted to span between said first and second sides of said container;
a plurality of pairs of rod supports secured to said first and second sides of said container proximate to said open top, adapted to removably receive said plurality of rigid elongate rods thereon; and
a plurality of rollers secured to a bottom of said container.

2. The apparatus of claim 1 wherein said container is formed in a generally rectangular configuration.

3. The apparatus of claim 1 wherein said container includes a longitudinal horizontal open slot extending through said container proximate to said bottom thereof.

4. The apparatus of claim 3 wherein said slot extends through a front or a back of said container.

5. The apparatus of claim 3 further comprising a removable tray corresponding to a bottom of said interior compartment and adapted to pass through said open slot.

6. The apparatus of claim 5 wherein said tray includes upright walls extending around a periphery thereof and defining a containment area therein.

7. The apparatus of claim 6 wherein said tray includes a handle extending outward from one of said upright walls.

8. The apparatus of claim 1 further comprising a lid adapted to enclose said open top.

9. The apparatus of claim 8 wherein said lid includes a locking mechanism adapted to secure said lid to said container.

10. The apparatus of claim 8 wherein said lid is attached to said container with a hinge.

11. The apparatus of claim 10 wherein said lid includes a locking mechanism adapted to secure said lid to said container and located at an opposite end of said lid to said hinge.

12. A method for transporting hanging crops comprising:
providing a container having a plurality of rollers secured to a bottom thereof, said container having an open top and defining an interior compartment extending between first and second sides and having a plurality of pairs of rod supports secured to said first and second sides of said container proximate to said open top, said pairs of rod supports adapted to removably receive a plurality of elongate rods thereon;
supporting a plurality of crops along each of said plurality of elongate rods, adapted to span between said first and second sides of said container;
lowering each of said plurality of elongate rods with said plurality of crops thereon into said interior compartment and suspending each of said plurality of elongate rods from said pairs of rod supports.
